(19) United States
(12) Patent Application Publication
(10) Pub. No.: US 2004/0111289 A1
(43) Pub. Date: Jun. 10, 2004

(54) Organization information management system

(76) Inventor: Ikuo Koumaru, Chiba (JP)

Correspondence Address: JAY H. MAIOLI, Copper & Dunham LLP, 1185 Avenue of the Americas, New York, NY, 10036, US

(21) Appl. No.: 10/681,892

(22) Filed: Oct. 9, 2003

(30) Foreign Application Priority Data
Oct. 30, 2002 (JP) P2002-315318

(51) Int. Cl. G06F 17/60

(52) U.S. Cl. 705/1

(57) ABSTRACT

An organization information management system of the present invention comprises includes an organization information management apparatus having an organization unit recording unit and a classified management information recording unit, a human resource database, and an education plan generating apparatus having an evaluation value calculating unit for generating an education plan based on the evaluation value obtained by the evaluation value calculating unit and spec specific skill information recorded in the organization information management apparatus.

### CROSS REFERENCE TO RELATED APPLICATION

This application claims priority from Japanese Priority Document No. 2002-315318, filed on Oct. 30, 2002 with the Japanese Patent Office, which document is hereby incorporated by reference.

### BACKGROUND OF THE INVENTION

1. Field of the Invention

This invention relates to an organization information management system to be utilized regarding a body having an organization structure such as business enterprise when carrying out an efficiency analysis and a study of measures for an improvement in an efficiency of the organization. Further this invention further relates to an organization information management apparatus, an education plan generating apparatus, a program for the organization information management system, and an information recording medium for recording the program for the organization information management system. Particularly, further this invention relates to an organization information management system, an organization information management apparatus, an education plan generating apparatus, a program for the organization information management apparatus, and an information recording medium capable of proposing suggestions for improving a construction of a total organization by analyzing the difference between an out put and an input of each organization as an added value.

2. Description of the Related Art

In a business enterprise or the like, various approaches are utilized for reconstructing functions of an organization while clarifying segmented roles and responsibilities of the organization. For example, it is proposed to make a worker placement plan in considering an aptitude of the worker, his/her working history, his/her desire and the like in a prior Japanese Laid-Open Patent H7-192045. Further in Japanese Laid-Open Patent H10-63716, it is proposed to carry out an appropriate decision for an education which members of the organization have to take in consideration of derived skill required for the function of the organization, or a worker placement which matches with the skill. Still further, in U.S. Pat. No. 5,416,694, it is proposed to analyze business work contents, carry out a personal evaluation of the worker, and inquire the skill required to the worker, and further carry out a worker dispatching which matches with the worker.

In these proposals, based on premise of a policy of an immediate upper section and a conventional function, the verification or analysis of the effects of the section is carried out, and as the result, the improvement of the roll and the responsibility to the section that attains no achievement is carried out within a range of adjacent sections. However, in the above mentioned proposals, although a partial improvement among sections is expected, but it is difficult to carry out an improvement for the total organization.

### SUMMARY OF THE INVENTION

Accordingly, the present inventors thought that in order to realize a Supply Chain Management (SCM) for an organization, it is necessary to process information relating to resources of the organization and to exchange the information among the organizations, and resultantly invented the present invention.

It is one aspect of the present invention to propose an organization information management system, an organization information management apparatus, an education plan generating apparatus, a program thereof and an information recording medium for the program, wherein the difference between an input and an output of each organization is analyzed as an added value, a useless function or an organization necessitating an improvement are properly determined, and it is possible to improve a construction of the total organization.

According to the present invention, it is proposed an organization information management system which comprises: an organization information management apparatus having an organization unit recording unit for recording information for specifying an organization unit and output information from the organization unit by correlating to each other, and a classified management information recording unit for recording the output information from the organization unit, information for specifying class, and spec information required to a person who belongs to the organization by correlating to each other; a human resource database for recording the information for specifying the organization unit, the information for specifying class, information for specifying a person, and the spec information required to the specified person; and an education plan generating apparatus having an evaluation value calculating unit for calculating an evaluation value by carrying out a predetermined evaluation value processing for generating an education plan based on the evaluation value obtained by the evaluation value calculating unit and the spec information recorded in the organization information management apparatus.

According to the organization information management system of the present invention, the organization information management apparatus, the human resource database, and the education plan generating apparatus are correlated to each other, and accordingly it is possible to propose an effective suggestion relating to a human education.

Namely, in the organization information management apparatus of the present invention, it is possible to manage by linking the output information the information recorded in the organization unit recording unit and the information recorded in the classified management information recording unit as a relation. Accordingly, the output information is not possessed by different organizations, and it is able to decide whether there is a duplication on the organization or not, and accordingly, it is possible to discover the doubled organizations which cause an inefficiency on data.

Further the human resource database recodes the information for specifying an organization unit, the information for specifying a class, the information for specifying a person, and a personal spec of the person by correlating to each other, so that when a certain person is specified, then it is able to search his/her personal spec corresponding to the specified person.

Further, the education plan generating apparatus calculates an evaluation value by carrying out a predetermined evaluation value calculation based on the organization information management apparatus and the information recorded in the human resource database, then generates an education plan based on this evaluation value and the spec information recorded in the organization information management apparatus, so that it is able to provide an education plan which is the most suitable for the person. In this case, an evaluation value calculating unit searches the human resource database to extract a human spec information based on the information for specifying the person managed in the organization information management apparatus, and calculates an evaluation value in the organization unit based on the extracted human spec information.

In the above mentioned invention, the organization unit recording unit of the organization information management apparatus is able to further record input information as an input for the organization unit, support input information relating to a support received for outputting the output information, and support output information relating to a support done to the other organization unit for outputting the output information by correlating to each other.

In this case, the support information to be inputted to the organization unit recording unit of the organization information management apparatus may be only the support input information, or only the support output information, if necessary.

By additionally recording the input information, the support input information, and the support output information in addition to the output information in the organization unit recording unit, these appear to be added values of the input information and the output information. Because it becomes clear that what kind of added values are added and how they are added.

Further according to the present invention, the organization information management apparatus and the education plan generating apparatus for constituting the organization information management system are proposed.

Further according to the present invention, a program for a organization information management system or an information recording medium for the program which has a computer function as an organization information management system, an organization information management apparatus, or an education plan generating apparatus is proposed.

### BRIEF DESCRIPTION OF THE DRAWINGS

FIG. 1 is a block diagram showing an embodiment of an organization information management system in accordance with the present invention;

FIG. 2 is a chart showing one embodiment of a format of an organization unit storage unit in accordance with the present invention;

FIG. 3 is a chart showing one embodiment of a format of a classified management information recording unit in accordance with the present invention;

FIG. 4 is a chart showing one embodiment of a format of a human resource database in accordance with the present invention;

FIG. 5 is a chart showing another embodiment of a format of an organization unit recording unit in accordance with the present invention;

FIG. 6 is a chart showing one example of an added value of an organization unit in accordance with the present invention; and

FIG. 7 is a chart showing a continuity map of the organization unit in accordance with the present invention.

### DETAILED DESCRIPTION OF THE PREFERRED EMBODIMENT

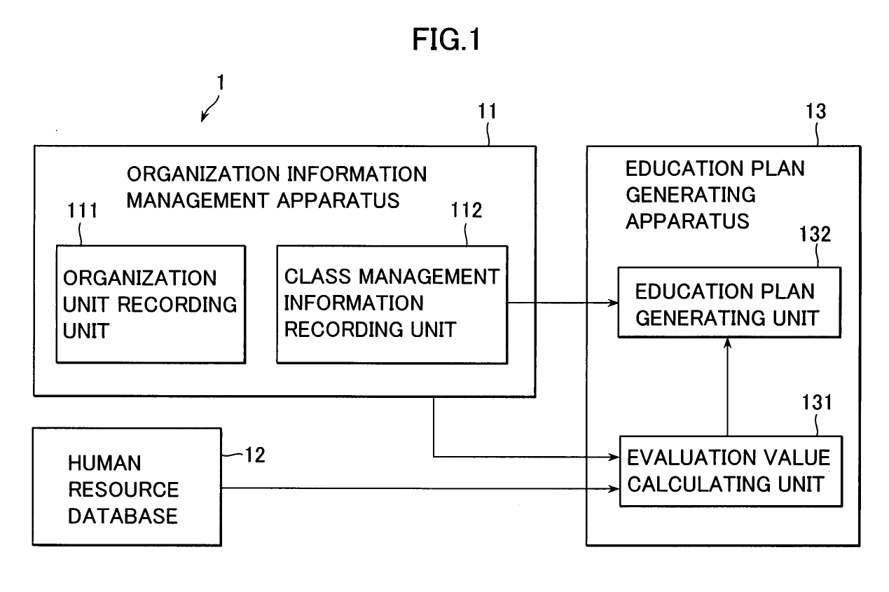

As shown in FIG. 1, an organization information management system 1 of the present embodiment comprises an organization information management apparatus 11, a human resource database 12 and an education plan generating apparatus 13. The organization information management apparatus 11 further comprises an organization unit recording unit 111 and a classified management information recording unit 112.

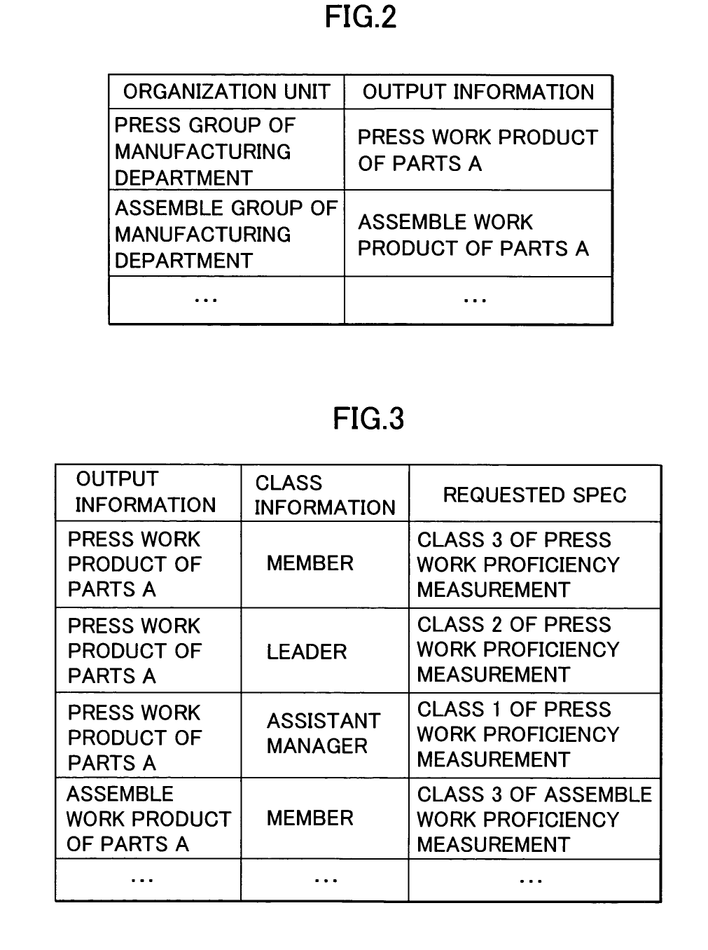

In the organization unit recording unit 111, an organization unit and output information of the organization unit are recorded by correlating to each other as shown in FIG. 2. In this case, the organization unit means an aggregation constituting an organization as a business enterprise, and as shown in FIG. 2, this aggregation corresponds to a section such as a press group of a manufacturing department or an assembly group of the manufacturing department. Further, the above mentioned output information corresponds to a business work result performed by the organization unit. For example, in the press group of the manufacturing department in FIG. 2, for example, a press work for parts A is carried out, so that a press work product of the parts A corresponds to the output information. On the contrary, in the assembly group of the manufacturing department, an assembly of the parts A is carried out, so that an assembled product of the parts A corresponds to the output information.

Further in the classified management information recording unit 112, the output information of the above mentioned organization unit, a classification information, and required spec information required to respective class are recorded by correlating to each other as shown in FIG. 3. In this case, the classification information means a human resource classification such as a cooperate ladder in the organization unit, and corresponds to a member, a leader, an assistant manager, and the like as shown in FIG. 3. Further, the required spec information means a skill such as a performance or a qualification required to a certain class of a certain output information. In case of the above example, a member whose output information is the press work product of the parts A is required to get the class 3 of the press work proficiency measurement, and when the member becomes a leader, then the member is required to get the class 2 of the press work proficiency measurement as the leader. This required spec information is not limited to one, but a plurality of the required spec information may be defined.

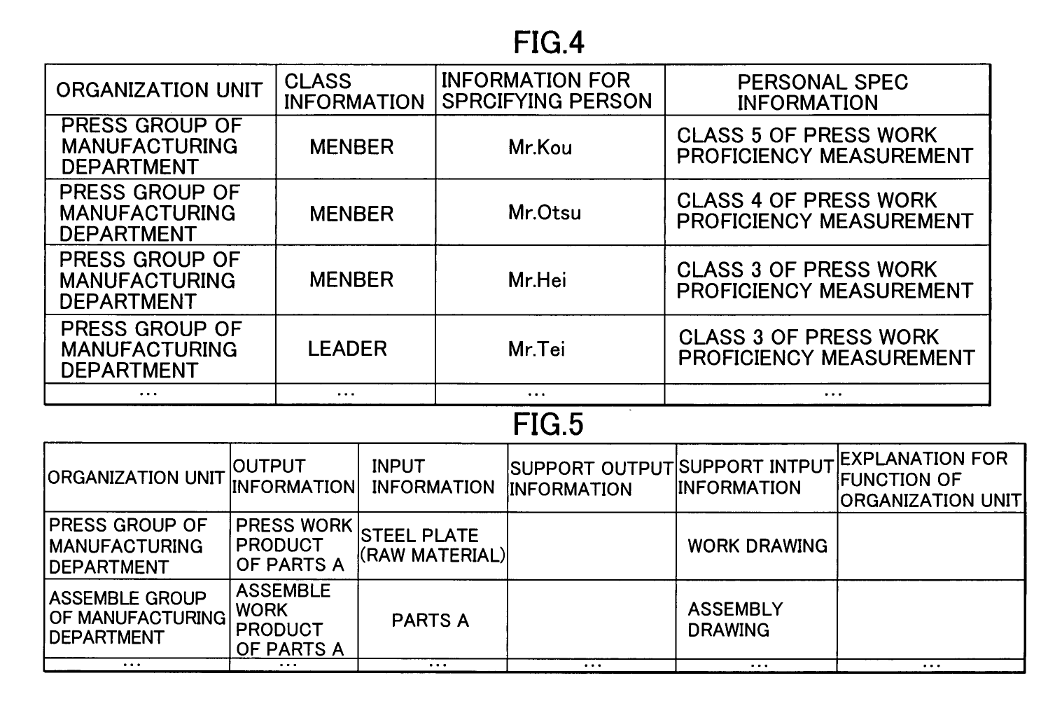

In the human resource database 12, the organization unit, the classification information, an information for specifying a person, and a personal spec of the specified person are recorded by correlating to each other as shown in FIG. 4. In this case, the information for specifying a person corresponds to an inherent identifier such as a name or a worker ID number. Further, the personal spec of the person means a current skill of the member or an acquired qualification related to the member. For example as shown in FIG. 4, it is recorded that Mr. Kou who belongs to the press group of the manufacturing department has a qualification of the class 5 of the press work proficiency measurement.

Back to FIG. 1, an evaluation value calculating unit 131 of the education plan generating apparatus 13 specifies a member, and evaluates using a predetermined evaluation value how much the specified member satisfies the spec required to the member of the organization unit where the specified member belongs. In this case, while the organization unit, the classification information and the personal spec information of the person are extracted as shown in FIG. 2 by referring the personal information of the human resource database 12 as keywords, the output information from the organization unit recording unit 111 of the organization information management apparatus 11 shown in FIG. 2 is extracted by referring the extracted organization unit as a key word. Then, the required spec is extracted from the classified management information recording unit 112 shown in FIG. 3 with reference to this output information and the classification information previously extracted from the human resource database 12. Thereby, the spec information required by the class of the person of the organization to which the person belongs is obtained. Then, it is possible to evaluate the person by comparing the spec information and the spec information previously extracted from the human resource database 12.

In case of evaluating Mr. Kou shown in FIG. 4, for example, Mr. Kou is specified in the human resource database 12. Thereby, it is read out that he/she is a member of the press group of the manufacturing department and has now the class 5 of the press work proficiency measurement. After that, the press work product of the parts A is extracted as the output information from the organization unit recording unit 111 shown in FIG. 2 by referring the press group of the manufacturing department as a keyword.

Subsequently, the class 3 of the press work proficiency measurement, which is the required spec, is extracted from the classified management information recording unit 112 as shown FIG. 3, by referring this press work products of the parts A and the member that is the classification information previously extracted from the human resource database 12 as key words. Namely the spec required to Mr. Kou is the class 3 of the press work proficiency measurement, and Mr. Kou does not attain the required spec even though he has the class 5 of the press work proficiency measurement.

The evaluation value calculating unit 131 calculates the personal spec relative to the required spec to get a predetermined evaluation value, for example, such as a performance level (%) and the like and transfers the same to the education plan generation unit 132.

In this education plan generation unit 132, the education database corresponding to the required spec is recorded in advance, and an appropriate education plan is generated from the education database in response to the transferred evaluation value. In the above mentioned Mr. Kou, for example, the class 3 of the press work proficiency measurement is required to all members of the manufacturing department press group to which Mr. Kou belongs, while Mr. Kou already has the class 5 of the press work proficiency measurement, so that an education plan for obtaining the class 4 of the press work proficiency measurement within 2 months and for obtaining the class 3 of the press work proficiency measurement following 2 months are generated.

As described above, according to the organization information management system 1 of the present invention, it is possible to generate education plans on different evaluation values by specifying a person, by automatically evaluating the spec required to the section and a business ladder of the specified person and the current skill of the person, and by referring to the education plan prepared in advance.

Further in the above mentioned embodiment, the organization unit recording unit 111 of the organization information management apparatus 11, only the organization unit and the output information are recorded by correlating to each other, but as shown in FIG. 5, in addition to the output information, the input information as the input for the organization unit, the support input information relating to the support for outputting the output information, and the support output information relating to the support to be done to the other organization unit upon outputting the output information may be recorded by correlating to each other.

In this case, the input information means the information which is the input of the organization unit, and in case of the press work of the parts A, such information corresponds to a trimming work for the steel plate constructing the parts A. Further, the support input information means the input information relating to the support which is accepted for outputting the output information as mentioned above, and in case of the above mentioned press work of the parts A, the steel plate which is raw material thereof, a press mold, a press apparatus, or a press design drawing corresponds to the input information.

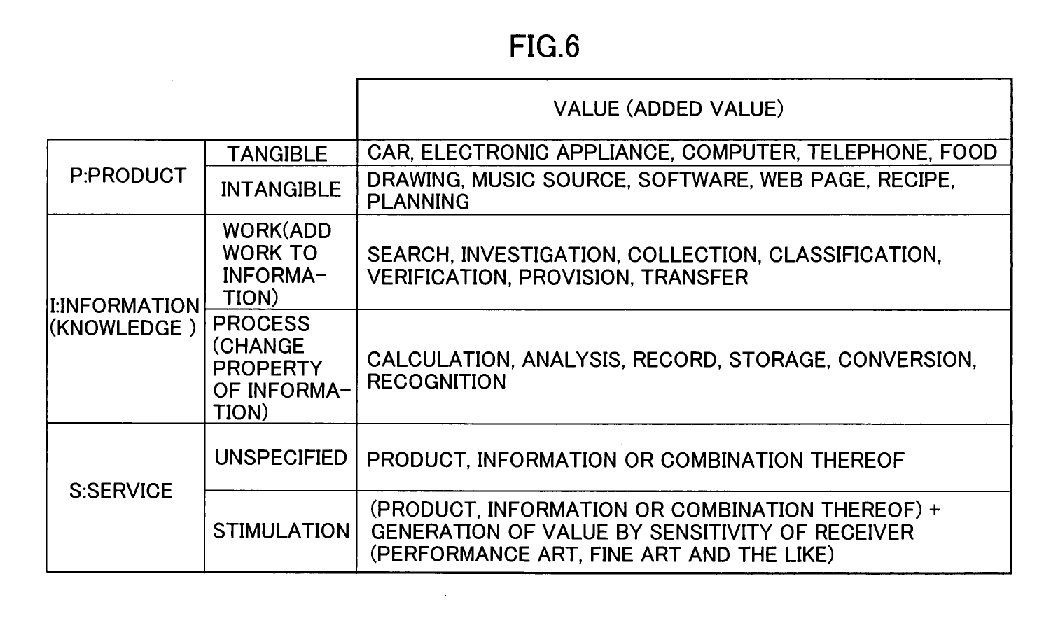

Further the support output information means a support to the other organization unit when outputting the output information. These input information, the support input information, and the support output information are favorably understood with reference to a classification table or the like of the added values such as shown in FIG. 6, for example.

In order to simplify the understandings, the relations among the output information, the input information, the support output information, and the support input information are explained in more detail.

As mentioned above, this invention is to a system for carrying out a SCM for the organization. Accordingly, in order to study the organization constituted by chaining a plurality of organization units, a mere work flow analysis causes a disadvantage. If listing up a sensuously understandable example, when it is able to manufacture good milk by having a cow listen to the music, the music is not the input information in this case. The food fed to the cow results the good milk, then the output information is the milk, and the input information should be this food in this case. Accordingly, in this case, the music is positioned as the support input information.

As same as above, in case of carrying out a particular output, the input necessary for constructing the output and a useful support input for processing the same are separately managed according to the present invention. In this case, what the other organization unit is able to utilize as the support input is placed as the support output.

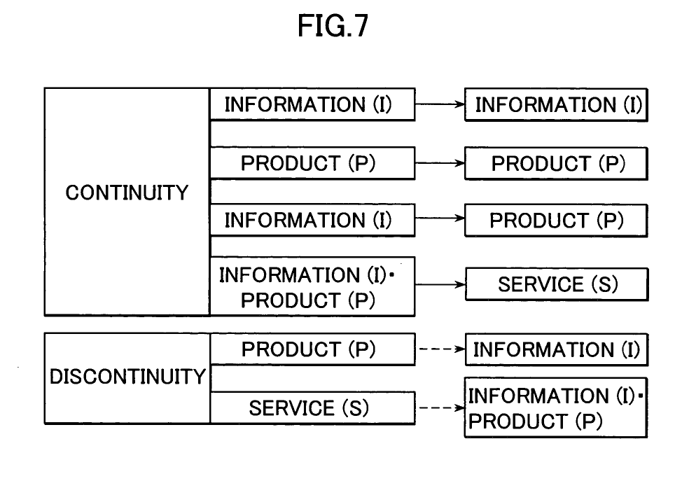

By positioning as described above, the output, the input, the support output, and the support input are defined, but on the contrary, the information corresponding to the input/output of those corresponds to any of Product (herein after referred to as P), Information (herein after referred to as I), and Service (herein after referred to as S), as shown in FIG. 6. Therefore, the processing at respective organization unit is to be included in any of the continuity/discontinuity as shown in FIG. 7. This means that as shown in FIG. 7, P, I, and S on the left side are employed as the input or the support input, and P, I, and S on the right side are employed as the output or the support output.

In this case, when considering from a view point of continuity/discontinuity, it means that the one which the organization unit can handle as input/output is the one relating to the combination having continuity, and in case of the combination including the discontinuity, this correspond to the support input and the support output. For example, in case of outputting I by inputting I, it means continuous, and this is the combination where the processing carried out by the organization unit as the input/output. Further, when P→I, this means that the organization unit employs P as the support input or employs I as the support output. If the verification is carried out by such method, the definition of the organization unit is able to be handled as justness in the SCM method.

Then, thus defined input, the output, the support output, the support input are able to be used for a skill analysis which is necessary for the organization unit. Specifically, such record for deriving the required spec information based on the relation between the support output information and the classification information is added to the classification management information that is recorded in the classified management information recording unit 112. Thereby, it is possible to propose candidates for further detailed education items.

By employing these support input information and support output information, these become added values of the input information and the output information, thereby it becomes apparent how to add the added value and which type of added value is added, so that the analysis by the SCM method becomes more accurate.

Further, the embodiment explained as above is described to simplify the understandings of the present invention, and is not described to limit the scope of the present invention. Accordingly, each element disclosed in the above embodiment may include modifications and equivalents within the scope of the present invention.

What is claimed is:

1. An organization information management system comprising:
an organization information management apparatus having an organization unit recording unit for recording information for specifying an organization unit and output information from the organization unit by correlating to each other, and a classified management information recording unit for recording said output information from the organization unit, information for specifying class, and spec information required to a person who belongs to the organization by correlating to each other;
a human resource database for recording said information for specifying the organization unit, said information for specifying class, information for specifying a person, and the spec information required to said specified person; and
an education plan generating apparatus having an evaluation value calculating unit for calculating an evaluation value by carrying out a predetermined evaluation value processing for generating an education plan based on the evaluation value obtained by said evaluation value calculating unit and the spec information recorded in said organization information management apparatus.

2. The organization information management system as cited in claim 1, wherein;
said organization unit recording unit of said organization information management apparatus records input information as an input for said organization unit, support input information relating to a support received for outputting said output information, and support output information relating to a support done to the other organization unit for outputting said output information by correlating to each other.

3. The organization information management apparatus which constitutes the organization information management system as cited in claim 1 or claim 2.

4. The education plan generating apparatus which constitutes the organization information management system as cited in claim 1 or claim 2.

5. A program for making a computer function as the organization information management system as cited in claim 1 or claim 2.

6. A program for making a computer function as the organization information management apparatus as cited in claim 3.

7. A program for making a computer function as the education plan generating apparatus as cited in claim 4.

8. An information recording medium to which the program as cited in any one of claim 5, claim 6 and claim 7.
